(19) United States
(12) Patent Application Publication
(10) Pub. No.: US 2007/0226610 A1
(43) Pub. Date: Sep. 27, 2007

(54) Data Processing System and Method

(76) Inventors: Ana Cristina Benso Da Silva, Porto Alegre (BR); Ioao Batista Souza De Oliveira, Porto Alegre (BR); Felipe Rech Meneguzzi, Porto Alegre (BR); Leonardo Luceiro Meirelles, Porto Alegre (BR)

Correspondence Address: LADAS & PARRY, 5670 WILSHIRE BOULEVARD, SUITE 2100, LOS ANGELES, CA, 90036-5679, US

(21) Appl. No.: 11/587,065

(22) PCT Filed: Apr. 28, 2005
(86) PCT No.: PCT/US05/15090

§ 371 Date: Oct. 19, 2006

(30) Foreign Application Priority Data
Apr. 30, 2004 (GB) 0409635.0

(51) Int. Cl. G06F 15/00

(52) U.S. Cl. 715/523; 715/517

(57) ABSTRACT

A system and method for grouping separate elements, having a common characteristic, to produce at least one of an output document corresponding to a presentation or for producing such a presentation.

### FIELD OF THE INVENTION

The present invention relates to a data processing system and method and, more particularly, to a print formatter system and method.

### BACKGROUND TO THE INVENTION

It is well known within the art that the Apache Software Foundation provides support for the Apache community of open source software projects. Apache projects are characterised by a collaborative, consensus based development process, an open and pragmatic software license, and a desire to create high quality software that leads the way in the field.

The Apache XML project, which forms part of the activities of the Apache Software Foundation, aims to provide commercial standard software-based XML solutions that are developed in an open and co-operative fashion, to provide feedback to standard bodies (such as IETF and W3C) from an implementation perspective and to be a focus for XML related activities within Apache projects.

One of the well-known Apache XML projects is the Formatting Objects Processor (FOP), which is a print or media formatter driven by XSL Formatting Objects (XSL-FO) to produce output independent formatted documents. The Formatting Object Processor is a Java application that reads a formatting object tree and renders the result in pages in a specified output format. The currently supported output formats include PDF, PCL, PS, SVG, XML (Area tree representation), Print, AWT, MFI and TXT. However, one skilled in the art appreciates that the primary output target is PDF.

Those skilled in the art understand that the goals of the Apache XML FOP project are to deliver an XSL-FO to PDF formatter that is compliant to at least the basic conformance level described in the W3C recommendation from 15 Oct. 2001, and that complies with the 11 Mar. 1999 Portable Document Format Specification (version 1.3) from Adobe Systems Incorporated, both of which are incorporated herein by reference for all purposes.

XSL-FO is an XML vocabulary that is used to specify pagination and other styling for page layout output. The acronym “FO” stands for Formatting Objects. XSL-FO can be used in conjunction with XSL-Transformations (XSL-T) to convert any XML format document into paginated layout ready for printing or displaying. XSL-FO defines a set of elements in XML that describes the way pages are set up. The contents of the pages are filled from content flows, which are essentially non-paginated descriptions of document content. There can be static flows that appear on every page such as, for example, headers and footers, and the main flow, which fills the body of the page. XSL-T describes the transformation of arbitrary XML into other XML (like XSL-FO), HTML or plain text for example.

Referring to FIG. 1, there is shown a process 100 for displaying or rendering XML. An XML document 102, that is, a document expressed using XML, can be displayed using an XML-enabled web browser 104, either alone or in conjunction with, for example, a CSS style sheet 106. Alternatively, and preferably, the XML document 102 can be displayed using an XSL display engine 108 preferably in conjunction with an XSL style sheet 110. A still further option for displaying or rendering the XML document 102 is to produce, for example, an HTML document 112 using an XSL transformation 114, of XSL, processor which processes both an XSL transformation specification 116 and the XML document 102. The resulting HTML document 112 can then be displayed using a conventional web browser 118.

However, FIG. 2 shows a preferred process 200 for producing a document from an XML source file 202. The XML source file or document 202 is processed by an XSLT processor 204 in conjunction with an XSLT style sheet 206. The XSLT processor 204 produces an XSL-FO file 208, which is, in turn, processed by a formatting objects processor 210 to produce an output document 212. As mentioned above, the output document 212 can have many formats. However, a preferred format is the portable document format (PDF) as described above.

As mentioned above an XSLT style sheet processor 204 accepts, as an input, XML data or an XML document 202 as well as an XSL style sheet 206. The XSLT style sheet processor 204 produces a presentation or representation of that XML source content according to a designer's intention. The designer's intention is, of course, expressed in the XSLT style sheet 206. The production of the presentation of the XML source content has at least two steps or involves at least two processes. Firstly, a result tree is constructed from the XML source tree or document 202 and, secondly, the result tree is interpreted to produce formatted results suitable for presentation on an intended display device or intended media. It is well understood within the art that the first process is known as a tree transformation and the second process is known as formatting. Typically, the process of formatting is undertaken by a formatter such as the formatting objects process described above.

It will be appreciated that the structure of the result tree may well be significantly different to the structure of an XML source tree. This follows from the processing or layout guidance contained within the XSLT style sheet 206. The format of an output document is produced by including formatting semantics within the result tree. These formatting semantics are, typically, expressed in terms of a catalogue of classes of formatting objects. Usually the nodes of the result tree correspond to or represent formatting objects. The various classes of formatting objects denote typographical abstractions such as, for example, page, paragraph, table etc as is well understood by those skilled in the art. The control of these abstractions is also provided in the form of formatting properties. The formatting properties can control aspects such as indents, word and letter spacing and widow, orphan and hyphenation control. Within XSL, the classes of formatting objects and the formatting properties provide a means for expressing presentation intent or intention.

An XSL style sheet is used in the first process, that is, the tree transformation. The style sheet contains a set of tree construction rules, which comprise two parts: namely, a pattern that is matched against elements of the source tree and a template that constructs a corresponding portion of the result tree using data associated with the matched pattern.

The process of formatting, which, as indicated above, is undertaken by a formatter, which interprets the results tree, in its formatting objects tree form, to produce a presentation that was intended by the designer of the style sheet from which the XML element and attribute tree in the “fo” name space was constructed.

As is well understood by those skilled in the art the vocabulary of formatting objects supported by XSL, that is, the set of “fo” element types, represents a set of typographical abstractions available to a layout designer. Each formatting object of the formatting element and attribute tree represents a specification of part of the pagination, layout and styling information that will be or will potentially be applied to the content of that formatting object as a result of formatting the whole result tree.

Formatting consists of the generation of a tree of geometric areas. Typically, those skilled in the art refer to such a tree of geometric areas as the area tree. The geometric areas are positioned on a sequence of one or more pages. Any given geometric area has associated characteristics such as, for example, a position on a page, an indication or specification of the content to be displayed within that area and may also have further specified attributes or characteristics such as, for example, background, padding and borders. As an example, formatting a single character generates an area of sufficient size to hold the glyph that is used to represent the character visually. The glyph is displayed in that area. It is well understood by those skilled in the art that geometric areas can be nested. Therefore, for example, a glyph may be positioned within a line, within a block, or within a page.

The process of rendering or producing the presentation intended by the designer takes the area tree, that is, the abstract model of the presentation expressed in terms of pages and their respective collections of areas, and causes the presentation to appear on or within a selected medium or in a format suitable for a selected medium. The selected medium can be, for example, a browser window on a computer screen or sheets of paper or other appropriate medium. The first step of formatting is to objectify the elements and attribute tree obtained by the XSLT transformation. Objectification of the result tree comprises turning the elements of the tree into formatting object nodes and the corresponding attributes of the result tree into property specifications. This step creates what is known within the art as the formatting object tree.

A second phase of formatting comprises refining the formatted object tree to produce a refined formatting object tree. The refinement process addresses the mapping of properties and traits. This comprises (1) shorthand expansion into individual properties, (2) mapping of corresponding properties, (3) determining computed values, which, itself, may comprise expression evaluation, (4) handling white-space treatment and line-feed treatment property effects, and (5) inheritance.

A third step in formatting is the construction of the area tree. The area tree is generated as described in the semantics of each formatting object. The traits applicable to the formatting object class control how the areas are generated. Referring to FIG. 3, there is shown a summary of the process 300 of generating an area tree. An element of the result XML tree in the “fo” name space 302, together with its associated attributes 304 are objectified to produce a formatting object element 306 with associated properties 308, where appropriate. The formatting object element 306 is subjected to the refinement process in which the formatting object element 306 and the associated properties 308 are processed to produce a formatting object element 310 also having associated traits 312. The formatting element 310 and the associated traits 312 are used in an area generation process to produce an area 314 bearing corresponding traits 316 that were dictated by the traits 312 of the refined formatting object element 310. It can be appreciated from the example of the traits that the area, that is, the block-area 314, will be arranged to have an indent that starts at a position of 40 points and uses a font size of 20 points.

As indicated above, formatting is the process of turning the formatting objects tree into a tangible form suitable for output via an appropriate medium or mechanism such as, for example, printing on paper or output via an audio or visual device. Typically formatting involves the construction of an area tree, that is, an audit tree containing geometric information associated with the placement or positioning of every glyph, shape etc in the document in conjunction with information, known as traits, describing associated spacing and other rendering constraints.

Formatting objects are elements in the formatting object tree, whose names are taken from the XSL name space. A formatting object belongs to a class of formatting objects identified by its element name. The behaviour of each class of formatting objects is described in terms of the respective areas created by the formatting object of that class as well as how the traits of the areas are established and how the areas are hierarchically structured with respect to areas created by other formatting objects. Some formatting objects are, for example, block-level and others are inline-level, which refer to the types of areas the respective formatting objects generate. This, in turn, refers to the default placement level. Inline areas such as, for example, glyph-areas, are collected into lines and the direction in which they are stacked is known as the inline-progression-direction.

There will now be described, for the sake of completeness, an area model. In XSL, the tree of formatting objects serves as an input or specification to be processed by the formatter, that is, the formatting objects processor. The formatter generates a hierarchical arrangement of areas, which comprise the formatted result.

In general, the formatter produces an area tree that describes or illustrates the relative geometric structuring of the output medium The structure of the tree can be described in terms of child, sibling, parent, descendant and ancestors. Each area tree has an initial or root node. Each area tree node other than the root is called an area. It is associated with a rectangular portion of the output medium. It will be appreciated by those skilled in the art that areas are not formatting objects and that a formatting object generates zero or more rectangular areas and, normally, each area is generated by the unique object in the formatting object tree.

The hierarchical structure 400 of an area is schematically illustrated in FIG. 4. It can be appreciated from FIG. 4 that an area has a content rectangle 402 which is the portion to which its child areas, if any, are assigned or within which they are effective. An area also has an optional padding rectangle 404 as well as an optional border rectangle 406. It is well known within the art that the outer bound of the border is called the border-rectangle and the outer bound of the padding is known as the padding-rectangle. The various areas or each area have or has a respective set of traits, that is, a mapping of names to values, in a similar way to which elements have attributes and formatting objects have properties. Individual traits are used for either rendering the area or for defining constraints on the result of formatting or both. Traits that are used only for formatting purposes or for defining constraints are known as formatting traits whereas traits that are used for rendering are known as rendering traits. As usual within the art, one skilled in the art understands that the semantics of each type of formatting object that generates areas is given in terms of which areas it generates and their place in the area tree hierarchy. This may be modified by interactions between the various types of formatting objects. The properties of the formatting object determine what areas are generated and how the formatting object's content is distributed among them.

The traits of an area are either: directly derived, that is, the values of directly-derived traits are the computed values of a property of the same or a corresponding name of the generating format object, or indirectly-derived, that is the values of indirectly-derived traits are the results of a computation involving the computed values of one or more properties of the generating formatting object, the other traits on this area or other interacting areas (ancestors, parents, siblings and children) and/or one or more values constructed by the formatter.

As indicated above there are two types of areas; namely, block-areas and inline-areas. These areas differ according to how they are processed or stacked by the formatter. An area can have block-area children or inline-area children according to the properties or characteristics of the generating formatting object. However, the children of any given area must all be of the same type. The line-area is a special kind of block-area whose children are all inline-areas. A glyph-area is a special kind of inline-area that has no child areas and bears only a single glyph image as its content. Examples of areas are a paragraph rendered using an fo:block formatting object, which generates block-areas, and a character rendered using an fo:character formatting object, which generates an Inline area.

An area has two associated directions that are derived from the generating formatting object's writing-mode and reference-orientation properties. The block-progression-direction is the direction for stacking block area descendants of an area and the inline-progression-direction is the direction for stacking inline-area descendants of that area. A further trait, known as the shift-direction, applies to inline-areas and refers to the direction in which base line shifts are applied as is well known by those skilled in the art. Furthermore, a trait known as the glyph-orientation defines the orientation of glyph images in the rendered results.

Each area has a trait top-position, bottom-position, left-position and right-position which respectively represent the distances from the edge of its content-rectangle to the correspondingly named edges of the nearest ancestor reference area (or page view-port-area in the case of areas generated by descendants or objects whose absolute-position is fixed). Traits known as the left-offset and the top-offset determine the amount by which a relatively positioned area is shifted for rendering. These traits receive their values during the formatting process or, in the case of absolutely positioned areas, during refinement.

Traits known as the block-progression-dimension and the inline-progression-dimension of an area represent the extent of the content-rectangle in each of the relative dimensions. For completeness, other traits include the following: the is-first and is-last traits are Boolean traits indicating the order in which areas are generated and returned by a given formatting object. The amount of space outside the border-rectangle can be defined using the space-before, space-after, space-start and space-end traits. The thickness of each of the four sides of the padding is governed by the padding-before, padding-after, padding-start and padding-end traits. The style, thickness and colour of each of the four sides of the boarder are similarly governed by the following traits: border-before, boarder-after, boarder-start and boarder-end. The background rendering of any area is controlled by background-colour and background-image traits amongst others. A nominal-font trait for an area is determined by the font properties and character descendants of the area's generating formatting object.

Referring to FIG. 5 there is illustrated, in greater detail, a block area 500 comprising a content rectangle 502, a padding rectangle 504 and a boarder rectangle 506. The spacing or positioning relationship between the content rectangle 502 and the padding rectangle 504 is clearly illustrated by the traits padding-start, padding-end, padding-before and padding-after. The position or relationship between the boarder rectangle 506 and the padding rectangle 504 is illustrated by the traits boarder-start, boarder-end, border-before and boarder-after. The relationship between the boarder rectangle 506 and the block area 500 is governed by the traits space-start, space-end, space-before and space-after. Further traits, start-indent and end-indent, define the position of the content rectangle 502 relative to the edges of the block area 500.

A line area is a special type of block area that is generated by the same formatting object that generated its parent area. As is well known by those skilled in the art, line areas do not have boarder and padding. Inline-areas are stacked within a line-area relative to a base line start point as indicated by the trait base line-start-point, which is a point determined by the formatter on the start-edge of the content rectangle of the line area.

As is well known within the art, the W3C organisation has produced a scaleable vector graphics standard, SVG 1.1, which is a modularised language for describing 2-dimensional vector and mixed vector/raster graphics in XML. The standard is incorporated herein by reference for all purposes.

When processing an XSL-FO file to create an SVG using Apache's formatting object processor, the resulting SVG file is surprisingly significantly greater than anticipated. The formatting objects processor generates an XML tag for every word of text. It will be appreciated that generating one SVG text object per word expressed within the XSL-FO file, even when these words share the same attributes, adds a significant overhead to an SVG representation of this text. Such behaviour is the result of the way in which FOP generates the Area Tree, and how the SVG generating module in FOP uses it to write the resulting SVG. Suitably, embodiments of the present invention provide a method for grouping flow or attributes of substantially similar or identical mark up elements or objects such as, for example, XML tags.

In preferred embodiments, content, corresponding to or derived from a respective <FO:flow> element or, more particularly, a plurality of such elements are made to correspond to a single respective element or XML tag.

For example, the following XSL-FO document

<fo:root xmlns:fo=“http://www.w3.org/1999/XSL/Format”>

<fo:layout-master-set>

<fo:simple-page-master master-name=“main”

margin-top=“36pt” margin-bottom=“36pt”
page-width=“8.5in” page-height=“11in”
margin-left=“72pt” margin-right=“72pt”
<fo:region-body margin-bottom=“50pt”
margin-top=“50pt”/>

</fo:simple-page-master>

<fo:layout-master-set>
<fo:page-sequence master-reference=“main”>

<fo:flow flow-name=“xsl-region-body”>

<fo:block font-size=“14pt” line-height=“17pt”>

```
Like most Open Source projects,
  <fo:inline
  font-style=“italic”>AbiWord<fo:inline>
```

started as a cathedral, but has become more like a bazaar.

</fo:block>

</fo:flow>

</fo:page-sequence>

</fo:root>

produces the output “Like most Open Sourced project, Abiword, started as a cathedral, but has become more like a bazaar”, is processed by Apache's formatting objects processor to produce the following document:

<svg:svg width=“451.275pt” height=“697.889pt”
xmlns:svg=“http://www.w3.org/2000/svg”>

<text x=“0.0” y=“9.816” style=“font-family:Times”>

Like

</text>

<text x=“24.996” y=“9.816” style=“font-family:Times”>

most

</text>

<text x=“51.336” y=“9.816” style=“font-family:Times”>

Open

</text>

<text x=“80.328” y=“9.816” style=“font-family:Times”>

Source

</text>

<text x=“116.652” y=“9.816” style=“font-family:Times”>

projects,

</text>

<text x=“160.644” y=“9.816”
style=“font-family:Times;font-style:italic”>

AbiWord

</text>

<text x=“208.968” y=“9.816” style=“font-family:Times”>

started

</text>

<text x=“243.96” y=“9.816” style=“font-family:Times”>

as

</text>

<text x=“256.956” y=“9.816” style=“font-family:Times”>

a

</text>

<text x=“265.284” y=“9.816” style=“font-family:Times”>

cathedral,

</text>

<text x=“315.264” y=“9.816” style=“font-family:Times”>

but

</text>

<text x=“333.6” y=“9.816” style=“font-family:Times”>

has

</text>

<text x=“352.596” y=“9.816” style=“font-family:Times”>

become

</text>

<text x=“392.916” y=“9.816” style=“font-family:Times”>

more

</text>

<text x=“420.576” y=“9.816” style=“font-family:Times”>

like

</text>

<text x=“441.576” y=“9.816” style=“font-family:Times”>

a

</text>

<text x=“0.0” y=“23.316” style=“font-family:Times”>

bazaar.

</text>

</svg:svg>

It can be appreciated that the size of the file produced is surprisingly large, which is undesirable. Accordingly, it is an object of embodiments of the present invention to at least mitigate some of the problems of the prior art.

### SUMMARY OF INVENTION

A first aspect of embodiments of the present invention provides a method for processing an input document, comprising a plurality of separate entities having a common characteristic to produce an output document having a predeterminable format; the method comprising the steps of identifying within the input document the plurality of entities having the common characteristic and creating an output entity in the output document comprising data associated with or derived from at least selectable ones of the plurality of entities.

Preferably, embodiments provide a method in which the plurality of entities comprises a plurality of formatting objects such as, for example, a plurality of at least one of elements and attributes or formatting object blocks and properties such as, for example, formatting objects before refinement, or formatting blocks and traits such as, for example, formatting objects after refinement.

Embodiments provide a method in which the input document is, or is at least associated with, at least one of an XML document, a XSLT style sheet document and an XSL-FO document.

Embodiments provide a method in which the output entities are PDF elements, XML elements or elements of a document governed by a standard.

Preferred embodiment provide a formatting method comprising the steps of converting an XML document into a XSL-FO document using a corresponding XSLT style sheet to produce a result tree; processing the result tree to produce an output document; the step of processing comprising the steps of: grouping a series words, having a common aspect, within a common element of in output document such that the common element contains a flow comprising the series of words having the common aspect or an aspect derived from such a common aspect.

Embodiments provide a method for creating a formatted output document, for example, a PDF document, complying with a predeterminable format; the method comprising the steps of: identifying, within a current XSL-FO area tree, or refined XSL-FO area tree, a current inline area, corresponding to a current inline object, of a current line area, corresponding to a current line object, of a current block area, corresponding to a current block object of the area tree; determining a characteristic associated with the current inline area. For example, checking the properties 308 or traits 312 or the XSL-FO area tree or the refined XSL-FO area tree). Then, adding the content of the current inline area to a current, corresponding, output document area such as, for example, a current output line or inline area, if the determining shows that the type of characteristic associated with the current inline area has a predeterminable association with a characteristic associated with the current output document area.

Embodiments preferably provide a method further comprising the step of rendering the or a current output document area. Therefore, it will be appreciated that the rendering can be performed on the fly or from a complete output document after that document has been constructed.

Embodiment provide a method in which the common characteristic is at least one of a common XML or XML-FO element, such as, for example, such as <text> . . . </text>, an XML or XML-FO attribute-value pair such as, for example, style=”font-family:Times, property or trait.

It will be appreciated that preferred embodiments of the present invention can be realised in the software of computer software running on a general purpose computer. Suitably, preferred embodiments provide a system comprising means to implement a method described or claimed herein.

Furthermore, embodiments provide a computer program comprising computer code to implement such a method or system. Preferred embodiments provide a computer readable product comprising storage storing such a computer program Therefore, embodiments can be realised in which the computer program is stored on a medium such as an optical or magnetic disc or in a chip, ROM or other memory device.

### BRIEF DESCRIPTION OF THE DRAWINGS

Embodiments of the present invention will now be described, by way of example only, with reference to the accompanying drawings in which:

FIG. 1 illustrates a first process for rendering an XML document;

FIG. 2 shows a second process for rendering an XML document;

FIG. 3 depicts, in further detail, a process for producing an area tree;

FIG. 4 illustrates a hierarchical structure of a area of an area tree;

FIG. 5 shows the area of FIG. 4 in greater detail;

FIG. 6 shows a flowchart of the processing performed by embodiments of the present invention; and

FIG. 7 depicts a flowchart of the rendering of documents produced according to embodiments of the present invention.

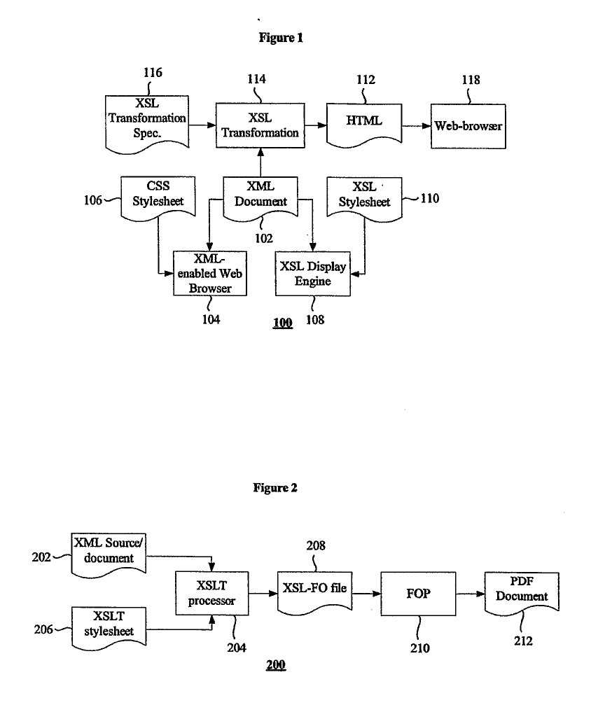

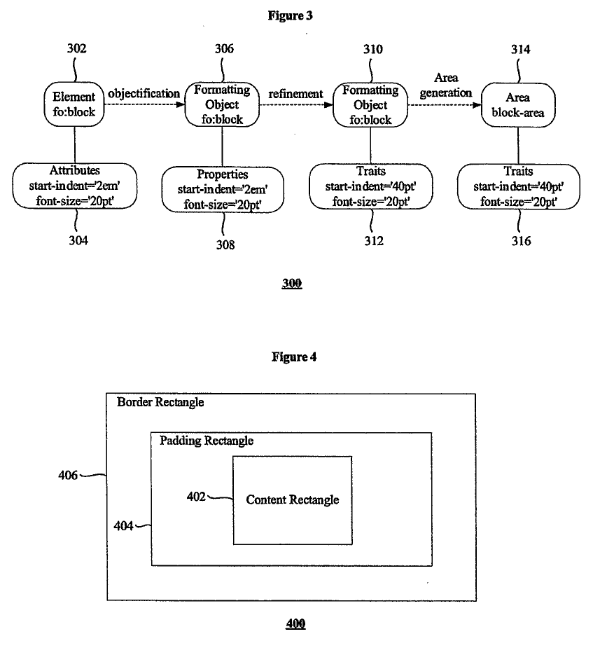

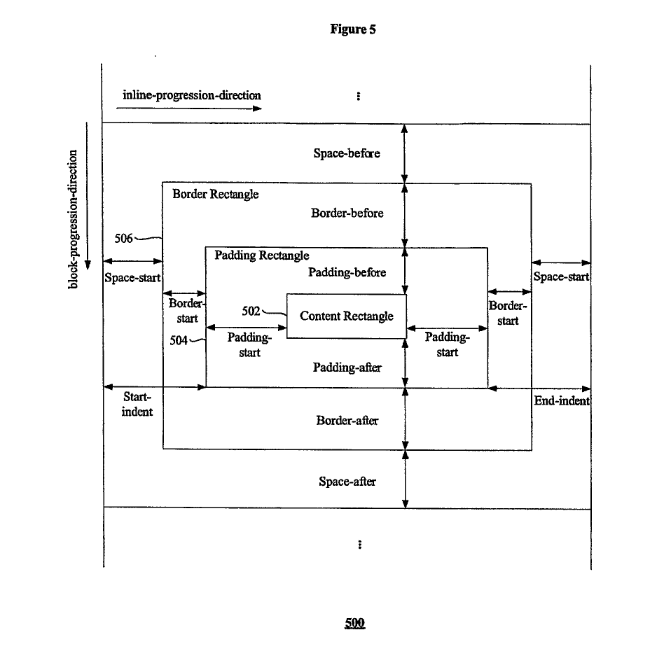

### DETAILED DESCRIPTION OF PREFERRED EMBODIMENTS

Areas relate to objects such as character, viewport, inline-container, a leader and space. A special inline area Word is also used for a group of consecutive characters.

Embodiments of the present invention group objects whose attributes are the same into lines within the same Text object so that a single, for example, SVG Text object, comprising a number of words, can be generated in the output instead of one object per word.

An embodiment of the present invention can be summarised by the following algorithm

1. Receive an XSL-FO Area Tree containing text objects;
2. For every Line Area in the Area Tree

A) Create a Merged Word Area;
B) For every Inline Area IA within the Line Area

| | |
|---|---|
| (i) | If the Merged Word Area is empty |

(a) Create a new Merged Word area holding IA

| | |
|---|---|
| (ii) | Else (Merged Word area containing text has already been |

| created) | |
|---|---|
| 1. | If IA is a Word Area and its attributes are the same |

as the Merged Word Area;

1.1 Merge Inline Area into Merged Word Area
1.2 Remove IA from the Line Area

| | |
|---|---|
| 2. | Else If IA is an Inline Space and its attributes are |

compatible with the Merged Word Area

2.1 Merge Inline Area into Merged Word Area
2.2 Remove IA from the Line Area

| | |
|---|---|
| 3. | Else (IA is either a different kind of area or its |

attributes do not allow merging)

3.1 Put Merged Word Area into the Line Area
3.2 Reset Merged Word Area to empty

3. Send the Area Tree to the renderer
4. For every Area in the Area Tree

A) If the Area is not a Merged Word Area

| | |
|---|---|
| (i) | Render the Area normally |

B) Else (the Area is a Merged Word Area)

| | |
|---|---|
| (i) | Calculate word spacing |
| (ii) | Render Merged Word Area using a single XML object |

In contrast to the extensive code produced by prior art FOPs described above, embodiments of the present invention produce the following document:

<svg:svg width=“451.275pt” height=“697.889pt”
xmlns:svg=“http://www.w3.org/2000/svg”>

<text x=“0.0” y=“9.816” style=“font-family:Times”>

Like most Open Source projects, </text>

<text x=“160.644” y=“9.816”
style=“font-family:Times;font-style:italic”>

AbiWord

</text>
<text x=“206.976” y=“9.816” style=“font-family:Times”>

started as a cathedral, but has become more like a

</text>
<g style=“font-family:Times”>

<text x=“0.0” y=“23.316”>

bazaar

</text>

</g>

</svg:svg>

from the above XSL-FO document.

Advantageously, it can be appreciated that the content “Like most open source projects, Abiword started as a cathedral, but has become a bazaar”, rather than each word being included with a respective <text . . . > XML tag, has been merged together to avoid the need to use so many <text> . . . </text> elements. It will be appreciated that this results in a significantly reduced file size and a potentially reduced processing overhead when rendering or transmitting the SVG document.

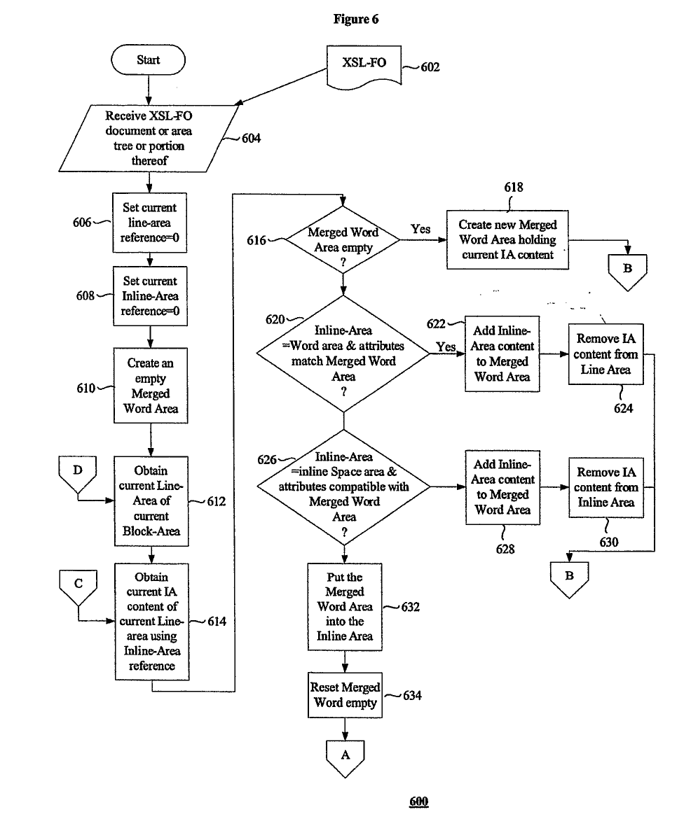

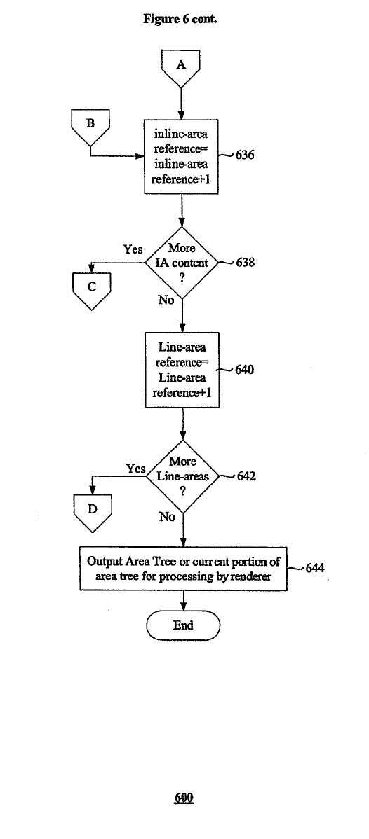

Referring to FIG. 6, there is shown a flowchart 600 for processing a document such as, for example, an XSL-FO document 602 to produce a rendered output, that is, presentation, or a document from which such an output or presentation can be derived.

The XSL-FO document 602 is processed by the FOP and the resulting Area Tree is received at step 604. Several control variables are established at steps 606, 608 and 610. In particular, a “current line-area reference” is set to zero at step 606, a “current inline-area of reference” is set to zero at step 608 and, at step 610, a merged word area is created in such a manner that it is empty.

A current line-area of a current block-area is obtained for processing at step 612. Data, IA, associated with a current inline-area and corresponding to, for example, a character or a glyph-area, is obtained from the current line-area using the inline-reference at step 614. A determination is made at step 616 as to whether or not the current merged word area is empty. If it is determined at step 616 that the current merged word area is empty, processing proceeds to step 618 where a “new” Merged Word Area is created. The newly-created Merged Word Area is arranged to have or contain the current content of the Inline Area. However, if the determination at step 616 is that the Merged Word Area is not empty, a determination is made at step 620 as to whether or not the current Inline-Area is a Word Area and that the attributes of the Inline-Area match the attributes of the merged word area. If the determination at step 620 is positive, the current inline-area content is added to the merged word area at step 622 in a manner dictated by the inline-progression-direction property or trait for the merged word area At step 624, the current Inline Area content is removed from the current Line Area. Processing then continues at point B.

However, if the determination at step 620 is such that the properties of the current inline area do not represent a word area or the attributes of the current inline-area do not match the traits of the current merged word area, processing proceeds to step 626. At step 626 a determination is made as to whether or not the properties of the current Inline-Area corresponds to an inline space area and as to whether or not the attributes of the current inline-area are compatible with the current merged word area. If the determination at step 626 is positive processing proceeds to step 628, where the current Inline-Area content is added to the current Merged Word Area. Thereafter, the current Inline-Area content is removed from the current Inline-Area at step 630. At this point it is important to distinguish that the term “match” applies to the comparison among different word areas, which contain the same set of possible attributes, namely, font-formatting and font decorations (underline, over line, line-through). Conversely, the term “compatible” applies to the comparison between inline spaces and word areas, which do not have the same set of attributes, and thus, the compatibility is checked only in terms of text decorations.

The “mergeable” condition checks three types of attributes. The first group regards font styles, the second regards text colors, and the third references other elements. These groups are surnarised below:
Font styles
   Font name
   Font size
   Font weight
   Font family
   Font style
   Font variant
   Letter spacing
Colors
   Red
   Green
   Blue
Text styles
   Overline
   Linethrough
   Underline

If the determination at step 626 is negative, the current merged word area is made to form part of a current inline area of the presentation to be rendered or the output document at step 632. Once the entire set of Line Areas of a given page are processed by an such algorithm the page is handed down to the rendering algorithm which then converts this modified tree into the desired presentation format.

It will be appreciated by one skilled in the art that pseudo-code of various aspects of embodiments of the present invention is provided in Tables 1 to 5 below. Each pseudocode aspect comprises an algorithm heading such as, for example, “Algorithm 1 WordMerging”, which provides an indication, in broad terms, of the function of the algorithm, a “Requires” heading, which provides an indication of the requirements of, or parameters used by, the algorithm, and an “Ensures” heading, which provides an indication of the function performed by the algorithm

TABLE 1
Algorithm 1 WordMerging
Requires: AreaTree such that AreaTree contains text LineAreas
Ensures: InlineAreas will have chunks of text merged within
MergedWordAreas
currentMergedWordArea [symbol] NULL
for all lineArea [symbol] AreaTree do

for all inline [symbol] lineArea do

if currentMergedWordArea = NULL then

currentMergedWordArea [symbol] createMergedWordArea(inline)

else if (inline is WordArea) and (mergeable(inline,
currentMergedWordArea)) then

currentMergedWordArea [symbol] mergeWordArea(inline,
currentMergedWordArea)
remove inline from lineArea

else if (inline is InlineSpace) and (mergeable(inline,
currentMergedWordArea) then

currentMergedWordArea [symbol] mergeInlineSpace(inline,
currentMergedWordArea)
remove inline from lineArea

else

currentMergedWordArea [symbol] NULL
advance to next inline

end if

end for

end for

TABLE 2
Algorithm 2 MergeWordArea
Require: inline such that inline is a WordArea
Require: MergedWordArea ≠NULL
Ensure: inline will be merged into MergedWordArea and its attributes
updated
move the text from inline into currentMergedWordarea
remove inline

TABLE 3
Algorithm 3 MergeInlineSpace
Require: inline such that inline is a InlineSpace
Require: MergedWordArea ≠NULL
Ensure: inline will be merged into MergedWordArea and the total spacing
size will be stored
add a space character into currentMergedWordArea
remove inline

TABLE 5
Algorithm 4 Mergeable
Require: inline
Require: MergedWordArea ≠NULL
Ensure: inline can be merged into MergedWordArea
for all attribute [symbol] inline do

if attribute in inline matches attribute in MergedWordArea then

return true

end if

end for

TABLE 5
Algorithm 5 RenderMergedWordArea
Require: Merged WordArea ≠NULL
Ensure: Merged WordArea is rendered to a single svg:text object
create an svg:text object for the text in MergedWordArea
add to the svg:text the word-spacing attribute
Let InlineSpaceSize be the FOP calculated size for an inline space
Let SpaceCharSize be the FOP selected font's space character size
Let n be the total number of spaces between words within a given line
$wordspacing = \frac{( {\sum }_{i = 0}^{n} ( {InlineSpaceSize}_{i} - SpaceCharSize ) )}{n}$

At step 634, the merged word area is arranged to be “empty”. Processing then proceeds to the point A.

Processing continues at points A and B at step 636 to point to the next inline-area character or aspect of the current line-area. In effect, at step 636, the inline-area reference is “incremented by one” so that it points to the next inline-area character or content. A determination is made, at step 638, as to whether or not the current line-area has further inline-areas, aspects or characters to be processed. If the determination at step 638 is positive, processing is transferred to point C. However, if the determination at step 638 is negative, the current line-area does not contain further inline-area content to be processed. Therefore, processing proceeds to step 614 where the next line-area reference is “incremented by one” to point to, and obtain, the next line-area for processing. A determination is made at step 642 and as to whether or not, given the newly “incremented” line-area reference, there are further line-areas to be processed. If the determination at step 642 is positive, processing proceeds from point D, that is, step 612. However, if the determination at step 642 is negative, the current merged word area, that is, portion of the area tree of an output document or representation of at least part of a presentation as intended by a designer, is output for rendering or further processing at step 644.

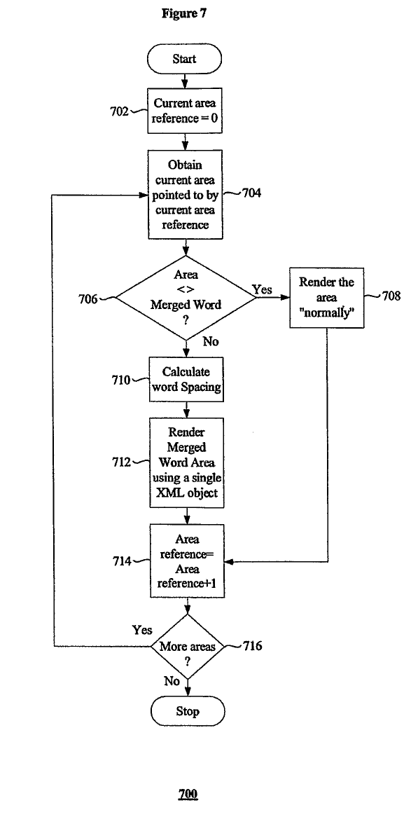

Referring to FIG. 7, there is shown a flowchart 700 for rendering the data output at either of steps 634 and 644. A current area reference is set to zero at step 702. The current area pointed to by the current area reference is obtained or received at step 704. A determination is made at step 706 as to whether or not the current area is not equal to a merged word area. If the determination at step 706 is positive, the current area is rendered as “normal” at step 708. However, if the determination at step 706 is the negative, the word spacing for the content of the current area is calculated at step 710. The current area, that is, the merged word area or current merged word area, is rendered as a single SVG text object at step 712. At step 714 the current area reference is “incremented by one” to point to the next line area for processing. A determination is made at step 716 as to whether or not there are further areas to be processed. If the determination at step 716 is positive, processing proceeds from step 704. However, if the determination at step 716 is negative, processing terminates.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings) and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A method for processing an input document, comprising a plurality of separate entities having a common characteristic to produce an output document having a predeterminable format; the method comprising the steps of identifying within the input document the plurality of entities having the common characteristic and creating an output entity in the output document comprising data associated with or derived from at least selectable ones of the plurality of entities.

2. A method as claimed in claim 1 in which the plurality of entities comprises a plurality of formatting objects such as, for example, a plurality of at least one of elements and attributes or formatting object blocks and properties or formatting blocks and traits.

3. A method as claimed in claim I in which the input document is, or is at least associated with, at least one of an XML document, a XSLT style sheet document and an XSL-FO document.

4. A method as claimed in claim I in which the output entities are PDF elements, XML elements or elements of a document governed by a standard.

5. A formatting method comprising the steps of converting an XML document into a XSL-FO document using a corresponding XSLT style sheet to produce a result tree; processing the result tree to produce an output document; the step of processing comprising the steps of: grouping a series words, having a common aspect, within a common element of in output document such that the common element contains a flow comprising the series of words having the common aspect or an aspect derived from such a common aspect.

6. A method for creating a formatted output document complying with a predeterminable format; the method comprising the steps of:
identifying, within a current XSL-FO area tree, or refined XSL-FO area tree, a current inline area, corresponding to a current inline object, of a current line area, corresponding to a current line object, of a current block area, corresponding to a current block object of the area tree;
determining a characteristic associated with the current inline area;
adding the content of the current inline area to a current, corresponding, output document area if the determining shows that the type of characteristic associated with the current inline area has a predeterminable association with a characteristic associated with the current output document area.

7. A method as claimed in claim 6, further comprising the step of rendering the or a current output document area.

8. A method as claimed in claim 1 in which the common characteristic is at least one of a common XML or XML-FO element, an XML or XML-FO attribute-value pair, property or trait.

9. A system comprising means to implement a method as claimed in claim 1.

10. A computer program comprising computer code to implement a method or system as claimed in claim 1.

11. A computer readable product comprising storage storing a computer program as claimed in claim 10.
